(19) United States
(12) Patent Application Publication
(10) Pub. No.: US 2013/0284714 A1
(43) Pub. Date: Oct. 31, 2013

(54) HEATER AND GLOW PLUG PROVIDED WITH SAME

(71) Applicants: Takeshi Okamura, Aira-shi (JP); Norimitsu Hiura, Krishima-shi (JP)

(72) Inventors: Takeshi Okamura, Aira-shi (JP); Norimitsu Hiura, Krishima-shi (JP)

(21) Appl. No.: 13/880,012

(22) PCT Filed: Oct. 26, 2011
(86) PCT No.: PCT/JP2011/074689

§ 371 Date: Jul. 10, 2013

(30) Foreign Application Priority Data
Oct. 27, 2010 (JP) 2010-240984

(51) Int. Cl. F23Q 7/22; H05B 3/42

(52) U.S. Cl. CPC F23Q 7/22; H05B 3/42
USPC 219/270; 219/541

(57) ABSTRACT

A heater includes: a resistor having a heat-generating portion; a lead joined to an end portion of the resistor; and an insulating base body covering the resistor and the lead, the lead being made to have a portion whose profile is narrowed toward a distal end on a heat-generating portion side of the lead, a joining portion of the resistor and the lead being a region where the resistor is spaced apart from the insulating base body through the lead as viewed in cross section perpendicular to an axial direction of the lead.

### TECHNICAL FIELD

The present invention relates to a heater which is utilized as, for example, a heater for ignition or flame detection in a combustion-type vehicle-mounted heating device, a heater for ignition for various combustion equipment such as an oil fan heater, a heater for a glow plug of an automobile engine, a heater for various sensors such as an oxygen sensor, a heater for heating of measuring equipment, and a glow plug provided with such a heater.

### BACKGROUND ART

A heater used in a glow plug of an automobile engine or the like is constituted of a resistor having a heat-generating portion, a lead and an insulating base body. The selection and the design of materials for these parts are made such that the resistance of the lead is smaller than the resistance of the resistor.

Here, a joining portion of the resistor and the lead forms a shape change point or a material composition change point. Accordingly, for the purpose of increasing a joining area so as to prevent the joining portion from being influenced by difference in thermal expansion caused by heat generation or cooling during a use period, as shown in FIG. 15, there has been known the structure where an interface between a resistor body and a lead is formed obliquely as viewed in cross section including an axis of the lead (in cross section taken along the axis of the lead) (see Patent Literatures 1 and 2, for example).

### CITATION LIST

### Patent Literature

Patent Literature 1: Japanese Unexamined Patent Publication JP-A 2002-334768
Patent Literature 2: Japanese Unexamined Patent Publication JP-A 2003-22889

### SUMMARY OF INVENTION

### Technical Problem

Recently, to optimize a combustion state of an engine, there has been adopted a drive method where a control signal from an ECU is formed into a pulse.

Here, a rectangular wave is used as a pulse in many cases. A rise portion of the pulse includes a high frequency component, and the high frequency component is transmitted along a surface portion of a lead. However, when a seam portion is formed in such a manner that a surface of the lead and a surface of the resistor which have different impedances from each other are laminated to each other, matching of impedance cannot be secured at the seam portion so that the high frequency component is reflected. Accordingly, the seam portion is locally heated, thus giving rise to a drawback that microcracks are generated in the seam portion between the lead and the resistor or a change in resistance value occurs in the seam portion.

Further, also when DC driving is adopted instead of pulse driving, the DC driving has the similar drawbacks. That is, a circuit loss is eliminated in a recent ECU and hence, aiming at the rapid temperature elevation, a large electric current flows into a resistor at the time of starting an operation of an engine. Accordingly, in the same manner as a rectangular wave of a pulse, a rise of power inrush becomes steep so that high power containing a high frequency component penetrates a heater, thus giving rise to the similar drawbacks.

The invention has been made in view of the above-mentioned conventional drawbacks, and it is an object of the invention to provide a heater in which generation of microcracks or the like in a joining portion of a resistor and a lead can be suppressed even when a large electric current flows into the resistor at the time of rapid temperature elevation and the like and a glow plug provided with the heater.

### Solution to Problem

The invention provides a heater including: a resistor including a heat-generating portion; a lead joined to an end portion of the resistor to surround the end portion of the resistor; and an insulating base body covering the resistor and the lead, the lead being made to have a portion whose profile is narrowed toward a distal end on a heat-generating portion side of the lead, a joining portion of the resistor and the lead including a region where the resistor is spaced apart from the insulating base body through the lead as viewed in cross section perpendicular to an axial direction of the lead.

The invention provides a glow plug including the heater having the above-mentioned constitution, and a metal holder which is electrically connected to a terminal portion of the lead and holds the heater.

### Advantageous Effects of Invention

According to the heater of the invention, the lead is joined to the resistor to surround the resistor while decreasing a cross-sectional area thereof by narrowing a profile toward a distal end on a heat-generating portion side of the lead. Accordingly, even in a joining portion of the lead and the resistor having different impedances, no sharp mismatching of impedances is generated in a region where a high frequency component propagates. As the result, the high frequency component is not reflected so that matching of impedances at a seam portion between the lead and the resistor can be secured. Accordingly, irrespective of whether driving is pulse driving or DC driving, even when a rise of power inrush becomes steep, no microcracks or the like are generated in the seam portion between the lead and the heat-generating portion and hence, the resistance becomes stable for a long period. Eventually, the reliability and the durability of the heater are enhanced.

### BRIEF DESCRIPTION OF DRAWINGS

FIG. 1 is a longitudinal cross-sectional view showing one embodiment of a heater of the invention;

FIG. 2(a) is an enlarged cross-sectional view showing a section A in FIG. 1 which includes joining portions between a resistor and leads in an enlarged manner, and FIG. 2(b) is a transverse cross-sectional view taken along the line X-X in FIG. 2(a);

FIG. 3 is an enlarged perspective view of the joining portion of the resistor and the lead in a section B shown in FIG. 2(a);

FIG. 4(a) is a longitudinal cross-sectional view showing another embodiment of a heater according to the invention, FIG. 4(b) is a transverse cross-sectional view taken along the line X-X shown in FIG. 4(a), and FIG. 4(c) is a transverse cross-sectional view taken along the line Y-Y shown in FIG. 4(a);

FIG. 5 is an enlarged perspective view of a joining portion of the resistor and the lead in a section B shown in FIG. 4(a);

FIG. 6(a) is a longitudinal cross-sectional view showing another embodiment of a heater of the invention, and FIG. 6(b) is a transverse cross-sectional view taken along the line X-X shown in FIG. 6(a);

FIG. 7(a) is a longitudinal cross-sectional view showing another embodiment of a heater of the invention, and FIG. 7(b) is a transverse cross-sectional view taken along the line X-X shown in FIG. 7(a);

FIG. 8(a) is a longitudinal cross-sectional view showing another embodiment of a heater of the invention, and FIG. 8(b) is a transverse cross-sectional view taken along the line X-X shown in FIG. 8(a);

FIG. 9(a) is a longitudinal cross-sectional view showing another embodiment of a heater of the invention, and FIG. 9(b) is a transverse cross-sectional view taken along the line X-X shown in FIG. 9(a);

FIG. 10(a) is a longitudinal cross-sectional view showing another embodiment of a heater of the invention, and FIG. 10(b) is a transverse cross-sectional view taken along the line X-X shown in FIG. 10(a);

FIG. 11(a) is a longitudinal cross-sectional view showing another embodiment of a heater of the invention, and FIG. 11(b) is a transverse cross-sectional view taken along the line X-X shown in FIG. 11(a);

FIG. 12(a) is a longitudinal cross-sectional view showing another embodiment of a heater of the invention, and FIG. 12(b) is a transverse cross-sectional view taken along the line X-X shown in FIG. 12(a);

FIG. 13(a) is a longitudinal cross-sectional view showing another embodiment of a heater of the invention, and FIG. 13(b) is a transverse cross-sectional view taken along the line X-X shown in FIG. 13(a);

FIG. 14(a) is a longitudinal cross-sectional view showing another embodiment of a heater of the invention, and FIG. 14(b) is a transverse cross-sectional view taken along the line X-X shown in FIG. 14(a); and

FIG. 15(a) is a longitudinal cross-sectional view showing a conventional heater, and FIG. 15(b) is a transverse cross-sectional view taken along the line X-X shown in FIG. 15(a).

### DESCRIPTION OF EMBODIMENTS

Hereinafter, embodiments of a heater of the invention are explained in detail in conjunction with drawings.

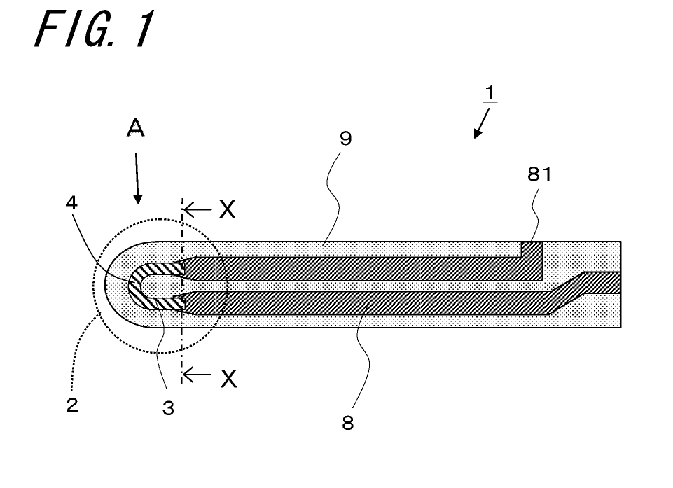

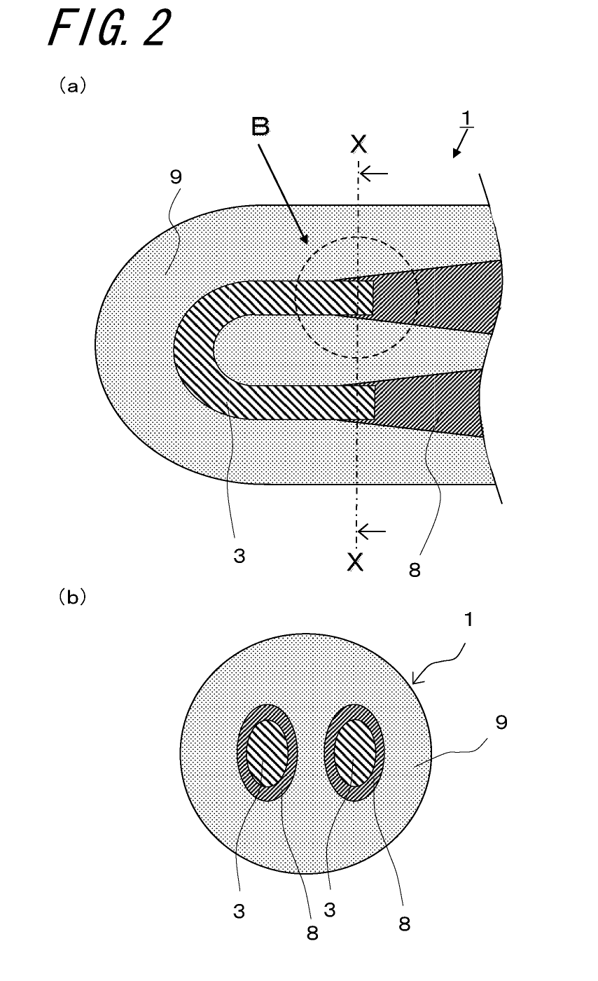

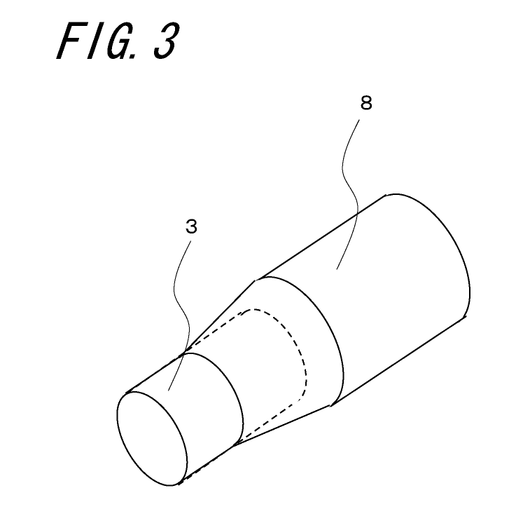

FIG. 1 is a longitudinal cross-sectional view showing one embodiment of a heater of the invention. Further, FIG. 2(a) is an enlarged cross-sectional view showing a section A in FIG. 1 which includes joining portions between a resistor and leads in an enlarged manner, and FIG. 2(b) is a transverse cross-sectional view taken along the line X-X in FIG. 2(a). FIG. 3 is an enlarged perspective view of the joining portion of the resistor and the lead in a section B shown in FIG. 2.

A heater 1 of this embodiment includes a resistor 3 including a heat-generating portion 4, leads 8 joined to end portions of the resistor 3 in such a state where the leads 8 surround the end portions of the resistor 3, and an insulating base body 9 covering the resistor 3 and the leads 8, the lead 8 being made to have a portion whose profile is narrowed toward a distal end on a heat-generating portion side of the lead 8, the joining portion of the resistor 3 and the lead 8 including a region where the resistor 3 is spaced apart from the insulating base body 9 through the lead 8 as viewed in cross section perpendicular to an axial direction of the lead 8.

The insulating base body 9 of the heater 1 of this embodiment is formed into a rod shape, for example. The insulating base body 9 covers the resistor 3 and the leads 8. In other words, the resistor 3 and the leads 8 are embedded in the insulating base body 9. The insulating base body 9 is preferably made of ceramics. Because of being made of ceramics, the insulating base body 9 can withstand a higher temperature than an insulating base body made of metal does and hence, it is possible to provide the heater 1 whose reliability at the time of the rapid temperature elevation can be further enhanced. To be more specific, as a material for forming the insulating base body 9, ceramics having an electrical insulating performance such as oxide ceramics, nitride ceramics or carbide ceramics can be named. Particularly, the insulating base body 9 is preferably made of silicon nitride ceramics. This is because silicon nitride which silicon nitride ceramics contains as a main component thereof is excellent in terms of high strength, high toughness, high insulation property and heat resistance. The silicon nitride ceramics can be obtained in such a manner that, for example, 3 to 12 mass % of rare earth element oxide such as Y₂O₃, Yb₂O₃ or Er₂O₃ which is provided as a sintering aid, 0.5 to 3 mass % of Al₂O₃, and 1.5 to 5 mass % of SiO₂ in terms of an amount of SiO₂ contained in a sintered body are mixed into silicon nitride which is the main component, the mixture is formed into a predetermined shape and, thereafter, the mixture is subjected to hot press firing at a temperature of 1650° C. to 1780° C., for example.

Further, when a body made of silicon nitride ceramics is used as the insulating base body 9, it is preferable to mix and disperse MoSiO₂, WSi₂ or the like into silicon nitride ceramics. In this case, it is possible to make a thermal expansion coefficient of silicon nitride ceramics which is a base material approximate a thermal expansion coefficient of the resistor 3, thus enhancing the durability of the heater 1.

The resistor 3 having the heat-generating portion 4 has a folded shape, for example, and a portion of the resistor 3 in the vicinity of an intermediate point of the folding forms the heat-generating portion 4 which generates heat most. As the resistor 3, a resistor which contains carbide, nitride, silicide or the like of W, Mo, Ti or the like as a main component can be used. When the insulating base body 9 is made of any one of the above-mentioned materials, from a viewpoint that the difference in a thermal expansion coefficient between the resistor 3 and the insulating base body 9 is small, from a viewpoint that the resistor 3 exhibits high heat resistance and from a viewpoint that the resistor 3 exhibits small specific resistance, tungsten carbide (WC) is excellent as the material of the resistor 3 among the above-mentioned materials. Further, when the insulating base body 9 is made of silicon nitride ceramics, it is preferable that the resistor 3 contain WC which is an inorganic conductive material as a main component thereof, and the content of silicon nitride to be added to WC is set to 20 mass % or more. For example, in the insulating base body 9 made of silicon nitride ceramics, a conductive component which forms the resistor 3 has a thermal expansion coefficient larger than a thermal expansion coefficient of silicon nitride and hence, the conductive component is usually in a state where a tensile stress is applied to the conductive component. To the contrary, by adding silicon nitride into the resistor 3, a thermal expansion coefficient of the resistor 3 is made to approximate a thermal expansion coefficient of the insulating base body 9 and hence, stress caused by the difference in thermal expansion coefficient between the resistor 3 and the insulating substrate body 9 at the time of elevating or lowering a temperature of the heater 1 can be alleviated.

Further, when the content of silicon nitride contained in the resistor 3 is 40 mass % or less, a resistance value of the resistor 3 can be made relatively small and stable. Accordingly, it is preferable that the content of silicon nitride contained in the resistor 3 falls within a range of from 20 mass % to 40 mass %. It is more preferable that the content of silicon nitride falls within a range of from 25 mass % to 35 mass %. As an additive to be added into the resistor 3 similar to silicon nitride, 4 mass % to 12 mass % of boron nitride may be added into the resistor 3 in place of silicon nitride.

Further, a thickness of the resistor 3 (a thickness in the vertical direction shown in FIG. 2(b)) is preferably set to approximately 0.5 mm to 1.5 mm, and a width of the resistor 3 (a width in the horizontal direction shown in FIG. 2(b)) is preferably set to approximately 0.3 mm to 1.3 mm. By setting the thickness and the width of the resistor 3 to values which fall within these ranges, the resistance of the resistor 3 is made small so that heat can be generated efficiently and, further, the adhesion of a lamination interface in the insulating base body 9 having the laminated structure can be held.

The leads 8 joined to the end portions of the resistor 3 can be formed using substantially the same materials as the resistor 3, and it is possible to use a lead which contains carbide, nitride, silicide or the like of W, Mo, Ti or the like as a main component. For example, by setting the content of the material for forming the insulating base body 9 in the lead 8 smaller than the content of the material for forming the insulating base body 9 in the resistor 3, a resistance value per unit length of the lead 8 can be made smaller than a resistance value per unit length of the resistor 3.

Particularly, from a viewpoint that the difference in a thermal expansion coefficient between the lead 8 and the insulating base body 9 is small, from a viewpoint that the lead 8 exhibits high heat resistance and from a viewpoint that the lead 8 exhibits small specific resistance, WC is preferable as the material for forming the lead 8. Further, it is preferable that the lead 8 contains WC which is an inorganic conductive material as a main component, and silicon nitride is added into WC such that the content of silicon nitride becomes 15 mass % or more. Along with the increase of the content of silicon nitride, it is possible to make a thermal expansion coefficient of the lead 8 approximate a thermal expansion coefficient of silicon nitride for forming the insulating base body 9. Further, when the content of silicon nitride is 40 mass % or less, a resistance value of the lead 8 is made small and becomes stable. Accordingly, it is preferable that the content of silicon nitride falls within a range of from 15 mass % to 40 mass %. It is more preferable that the content of silicon nitride falls within a range of from 20 mass % to 35 mass %. Instead of setting the content of a material for forming the insulating base body 9 in the lead 8 smaller than the content of the material for forming the insulating base body 9 in the resistor 3, the resistance value per unit length of the lead 8 may be set lower than the resistance value per unit length of the resistor 3 by making a cross-sectional area of the lead 8 larger than a cross-sectional area of the resistor 3.

The lead 8 is joined to the resistor 3 to surround the end portion of the resistor 3 when the joining portion is viewed in cross section perpendicular to the axial direction of the lead 8. Further, the lead 8 is made to have a portion whose profile is narrowed toward a distal end on a heat-generating portion 4 side of the lead 8. In other words, a thickness of the lead 8 is gradually decreased toward the distal end on the heat-generating portion 4 side of the lead 8. Further, the joining portion of the resistor 3 and the lead 8 is a region where the resistor 3 is spaced apart from the insulating base body through the lead 8 as viewed in cross section perpendicular to the axial direction of the lead 8. In this embodiment, the joining portion means a region where an interface between the resistor 3 and the lead 8 exists as viewed in cross section including an axis of the lead 8. The cross section including the axis of the lead 8 means a cross section taken along the axis of the lead 8 and parallel to the axial direction of the lead 8. Here, it is preferable that a longitudinal length of the joining portion (a distance in the longitudinal direction that the lead 8 surrounds an end portion of the resistor 3) is 0.01 mm or more.

Due to such a constitution, the lead 8 is joined to the resistor 3 to surround the resistor 3 while decreasing a cross-sectional area thereof by narrowing a profile toward the distal end on the heat-generating portion 4 side of the lead 8. Accordingly, a high frequency component which is propagated along a surface of the lead 8 expands a propagation region thereof in the inside of the lead 8 along with the decrease of a cross-sectional area of the lead 8 and, further, the high frequency component advances while also expanding the propagation region thereof to a surface of the resistor 3 existing on an inner diameter side of the lead 8, and the high frequency component propagates only on the surface of the resistor 3 at a finish end portion of the lead 8. Accordingly, even in a joining portion of the lead 8 and the resistor 8 having different impedances, no sharp mismatching of impedances is generated in the region where a high frequency component propagates. As a result, the high frequency component is not reflected so that matching of impedances at a seam portion between the lead 8 and the resistor 3 can be secured. That is, also in a case where a drive method where a control signal from an ECU is formed into a pulse is adopted, even when a high frequency component of a rise portion of a pulse propagates on the surface portion of the lead 8, the reflection of the high frequency component at a seam portion can be suppressed. Accordingly, it is possible to suppress the generation of local heating at the seam portion between the lead 8 and the resistor 3 and hence, no microcracks are generated in the seam portion whereby the resistance value becomes stable for a long period.

Further, also when DC driving is adopted instead of adopting pulse driving, the similar advantageous effects can be obtained. That is, when a large electric current is made to flow through a resistor at the time of starting an operation of an engine aiming at the rapid temperature elevation, in the same manner as a rectangular wave of a pulse, a rise of power inrush becomes steep so that high power containing a high frequency component rushes into the heater. However, even when the high power including the high frequency component rushes into the heater, it is possible to suppress the generation of local heating at the seam portion between the lead 8 and the resistor 3 and hence, no microcracks are generated in the seam portion whereby the resistance becomes stable for a long period.

Here, “the lead 8 is joined to the resistor 3 to surround the end portion of the resistor 3” means the structure where the lead 8 is formed into a shape such that the lead 8 has a recessed portion on a distal end side thereof, and the end portion of the resistor 3 is fitted into the recessed portion. The structure may have the following configurations.

In the heater 1 shown in FIGS. 2 and 3, the joining portion of the resistor 3 and the lead 8 is a region where the resistor 3 is spaced apart from the insulating base body 9 through the lead 8 over the whole circumference as viewed in cross section perpendicular to the axial direction of the lead 8. According to this configuration, the heater 1 has a region where an interface between the resistor 3, the lead 8 and the insulating base body 9 whose thermal expansion coefficient is largely different from thermal expansion coefficients of the resistor 3 and the lead 8 (a triple interface between the resistor 3, the lead 8 and the insulating base body 9) does not exist and hence, it is possible to prevent the generation of large stress concentration in an interface between the resistor 3 and the lead 8 in a cooling step during a use period. As a result, even when a temperature is elevated and lowered repeatedly, since the thermal expansion coefficients of the resistor 3 and the lead 8 are close to each other, it is possible to suppress the generation of cracks in the end portion of the joining portion. Accordingly, the reliability and the durability of the heater 1 are enhanced.

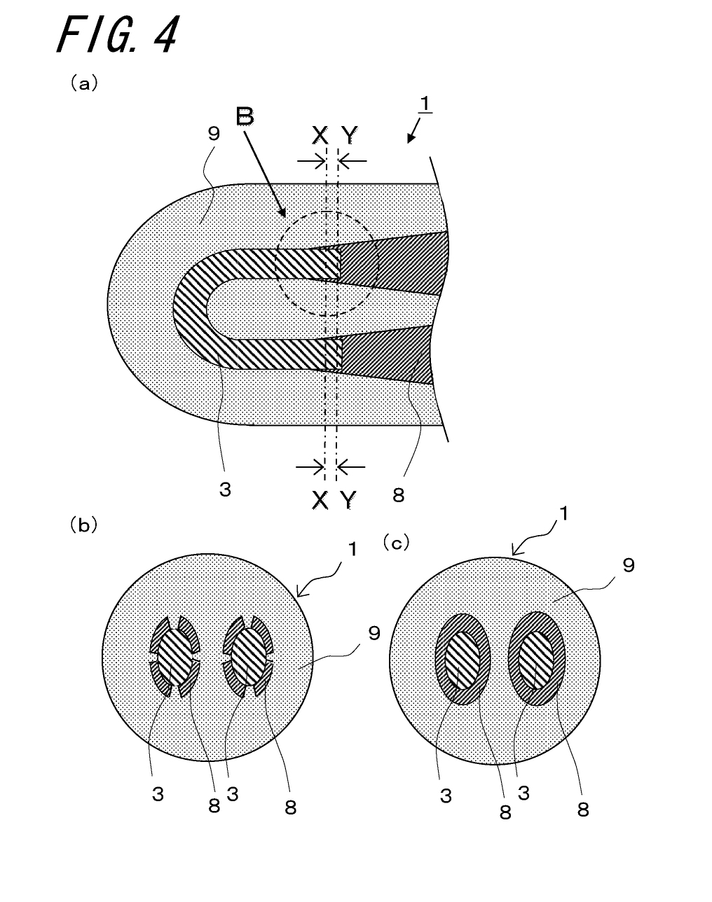

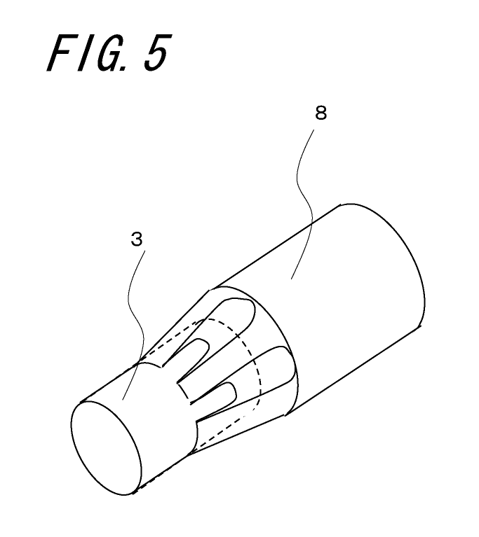

On the other hand, in the heater 1 shown in FIGS. 4 and 5, the lead 8 is joined to the resistor 3 to surround the end portion of the resistor 3 while changing an inclination angle of a portion of the lead 8 made to have a portion whose profile is gradually narrowed toward a distal end on a heat-generating portion 4 side of the lead 8 (tapered portion) without making the inclination angle uniform over the whole circumference. FIG. 4(a) is a longitudinal cross-sectional view showing another embodiment of the heater 1 according to the invention, FIG. 4(b) is a transverse cross-sectional view taken along the line X-X shown in FIG. 4(a), and FIG. 4(c) is a transverse cross-sectional view taken along the line Y-Y shown in FIG. 4(a). FIG. 5 is an enlarged perspective view of a joining portion of the resistor 3 and the lead 8 in a section B shown in FIG. 4(a). According to this embodiment, a distal-end region of the joining portion of the lead 8 and the resistor 3 is formed into a curved shape and, further, a contact area between the distal-end region and the insulating base body 9 is increased. Accordingly, not only it is possible to suppress the reflection of high frequency components in various frequency bands but also it is possible to dissipate heat into the insulating base body 9 even when a loss of high frequency components is converted into heat at the joining portion. Accordingly, the generation of local heating at the seam portion between the lead 8 and the resistor 3 can be suppressed and hence, no microcracks are generated in the seam portion whereby the resistance becomes stable for a long period, thus enhancing the reliability and the durability of the heater 1.

By joining the lead 8 to the resistor 3 to surround the resistor 3 while changing an inclination angle of the tapered portion of the lead 8 without making the inclination angle of the tapered portion of the lead 8 uniform over the whole circumference, a contact area between the resistor 3, the lead 8 and the insulating base body 9 is increased and hence, an adhesion strength among these parts is increased. Further, the joining configuration of these parts as viewed in cross section does not exhibit a circular shape but exhibits a petaloid shape and hence, even when thermal shock is suddenly applied to the heater 1, it is possible to provide a tough heater by alleviating stress caused by the difference in thermal expansion.

Further, the heater 1 according to this embodiment may have the following configuration as a modified example thereof.

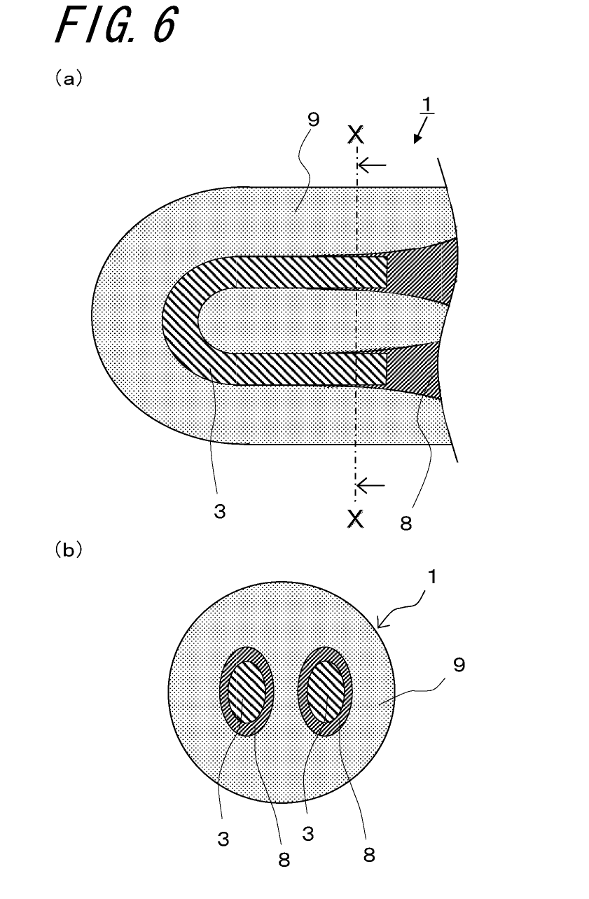

A heater 1 shown in FIG. 6 is a heater according to the modified example where a shape of a lead 8 according to the embodiment shown in FIGS. 2 and 3 is changed, wherein the portion of the lead 8 having the profile which is gradually narrowed includes a plurality of inclined regions as viewed in cross section including an axis of the lead 8, and the inclination on a distal end side is gentler than the inclination on a rear end side in the plurality of inclined regions. To be more specific, for example, the portion of the lead 8 having the profile which is gradually narrowed has a shape where a cross-sectional area is exponentially decreased as shown in the drawing. FIG. 6(a) is a longitudinal cross-sectional view showing another embodiment of the heater of the invention, and FIG. 6(b) is a transverse cross-sectional view taken along the line X-X shown in FIG. 6(a). Due to such a shape, irrespective of a frequency band, the heater 1 can acquire the configuration where the cross-sectional area of the lead 8 is decreased in such a manner that impedances match most and hence, no microcracks are generated in a seam portion whereby the resistance becomes stable for a long period. In other words, by exponentially decreasing the cross-sectional area of the lead 8, an amount of reflecting high frequency components is further decreased so that the generation of local heating at the seam portion between the lead 8 and the resistor 3 can be suppressed and hence, no microcracks or the like are generated in the seam portion whereby the resistance becomes stable for a long period. Eventually, the reliability and the durability of the heater 1 are enhanced.

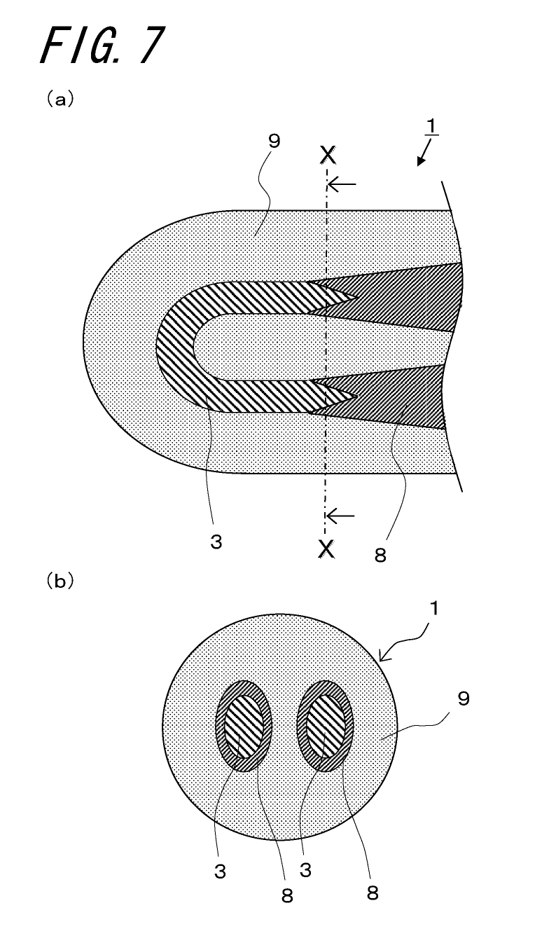

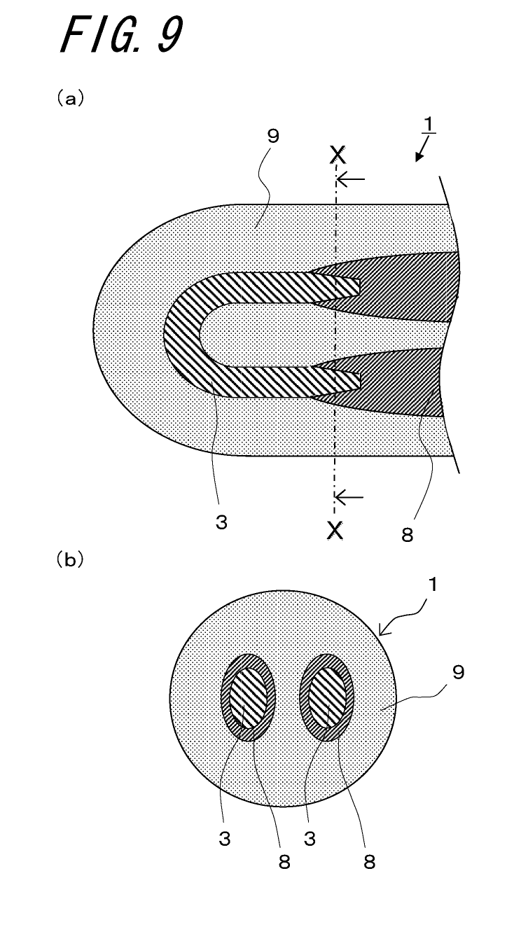

Heaters 1 shown in FIGS. 7 to 11 are configured such that a profile of a resistor 3 is narrowed toward a side opposite to a heat-generating portion 4 such that the resistor 3 has a tapered region in a joining portion. Due to such a shape, even when high frequency components are slightly reflected, the high frequency components are reflected along a boundary between the resistor 3 and a lead 8 and hence, a portion where local heating is generated can be confined in the inside of the lead. As a result, no microcracks are generated in a seam portion so that the resistance becomes stable for a long period.

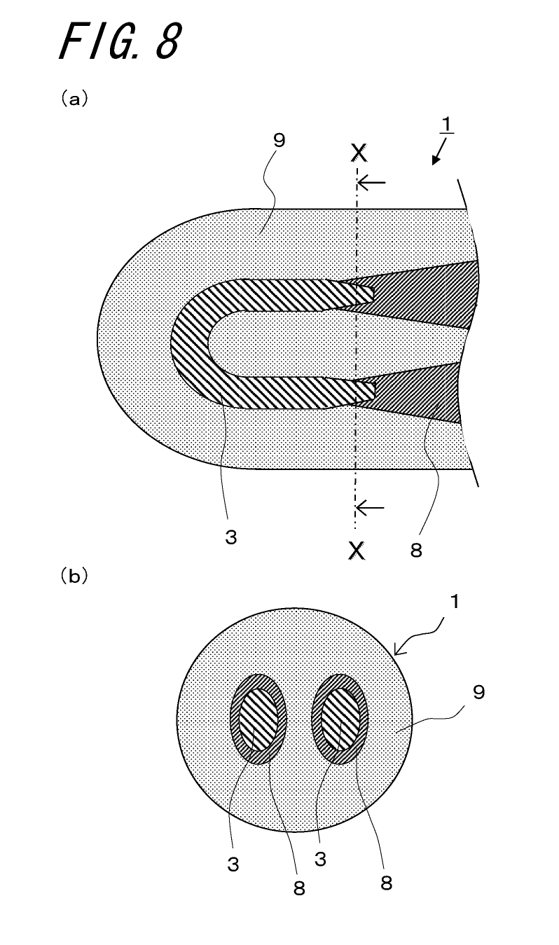

FIG. 7 show a case where a distal end of a resistor 3 on a side opposite to a heat-generating portion 4 has a pointed shape, and FIGS. 8 to 10 show cases where a distal end of a resistor 3 on a side opposite to the heat-generating portion 4 has a non-pointed end surface.

A longitudinal length (a horizontal length in the drawing) of a tapered region in FIGS. 7 to 11 is preferably set to 0.01 mm or more. Further, in the heaters 1 shown in FIGS. 8 to 10, it is preferable that a profile of the resistor 3 in the joining portion is narrowed toward a side opposite to the heat-generating portion 4 such that a cross-sectional area of the resistor 3 is decreased to 50% to 90%. Due to such a constitution, in a portion of the lead 8 where the cross section of the heater 1 perpendicular to the axial direction of the lead 8 includes the joining portion, a thermal expansion coefficient can be changed in an inclined manner toward a lead 8 side from a heat-generating portion 4 side, thus providing the heater constitution by which the sharp difference in thermal expansion is hardly generated.

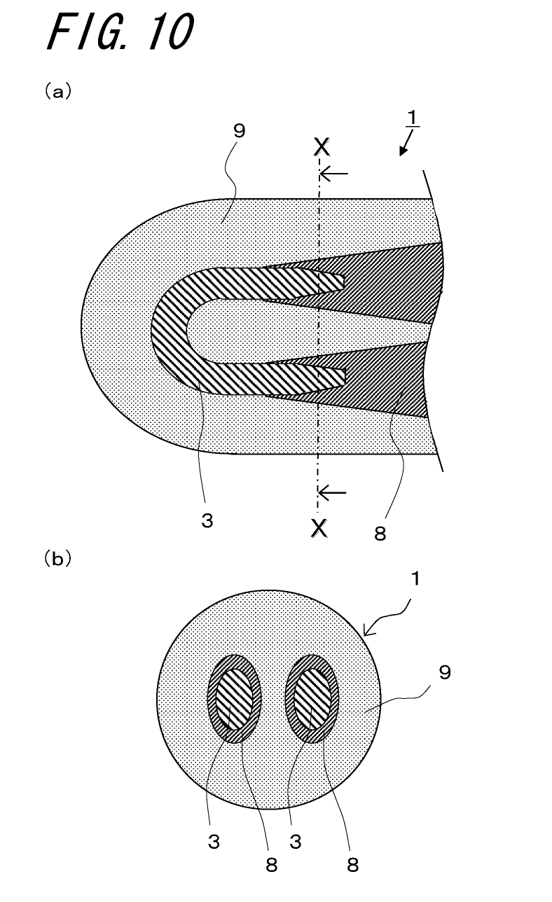

In the heater 1 of this embodiment, as shown in FIG. 10, it is preferable that a distal end on a heat-generating portion side of the lead 8 is positioned closer to the heat-generating portion than an initiation point of the tapered region of the resistor 3. Due to such a constitution, even when a seam portion is heated, the tapered distal end portion of the lead 8 cuts into the resistor 3 and hence, there is no possibility that the lead 8 is peeled off from the seam portion. Further, no microcracks are generated in the seam portion and hence, the resistance becomes stable for a long period.

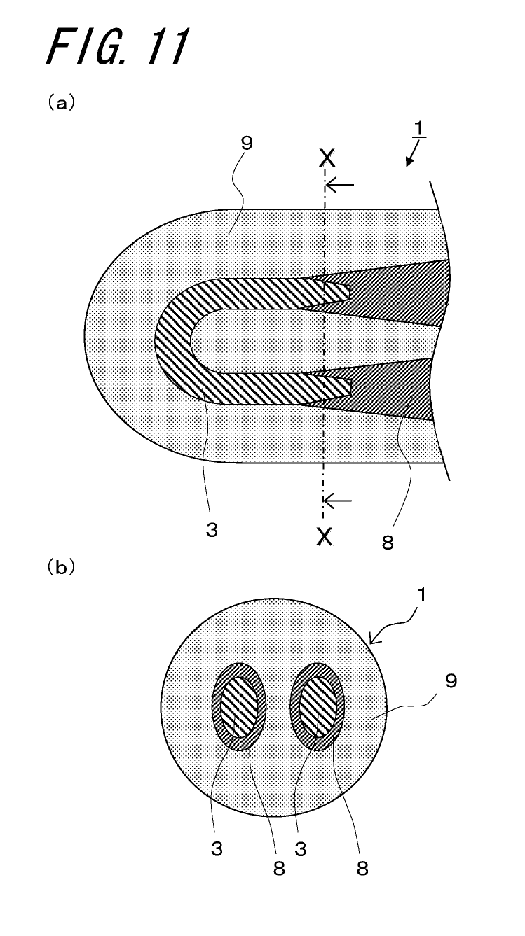

In the heater 1 of this embodiment, as shown in FIG. 11, a distal end of the lead 8 on a heat-generating portion side may be positioned at an initiation point of the tapered region of the resistor 3. Due to such a constitution, the heater 1 can be formed into a shape where impedances match most and hence, the reflection of high frequency components is not generated whereby heat is not generated.

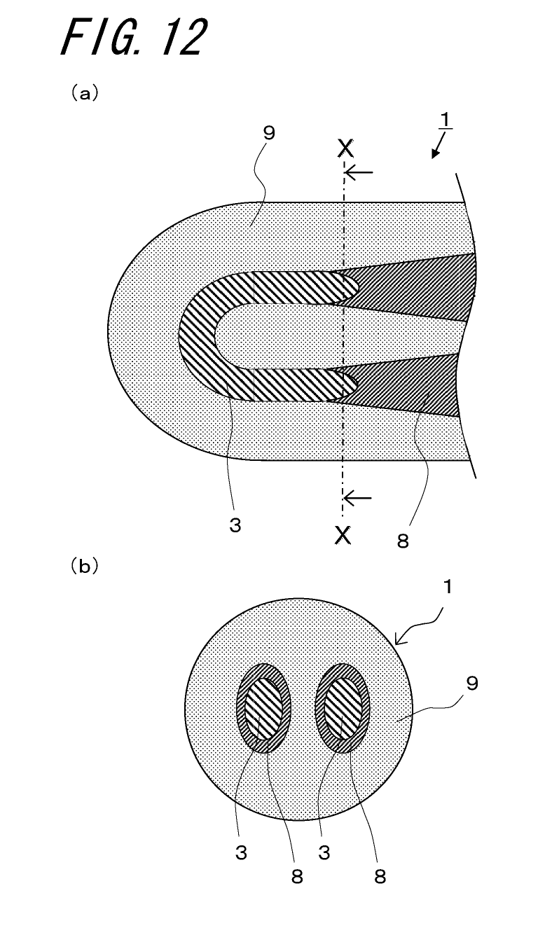

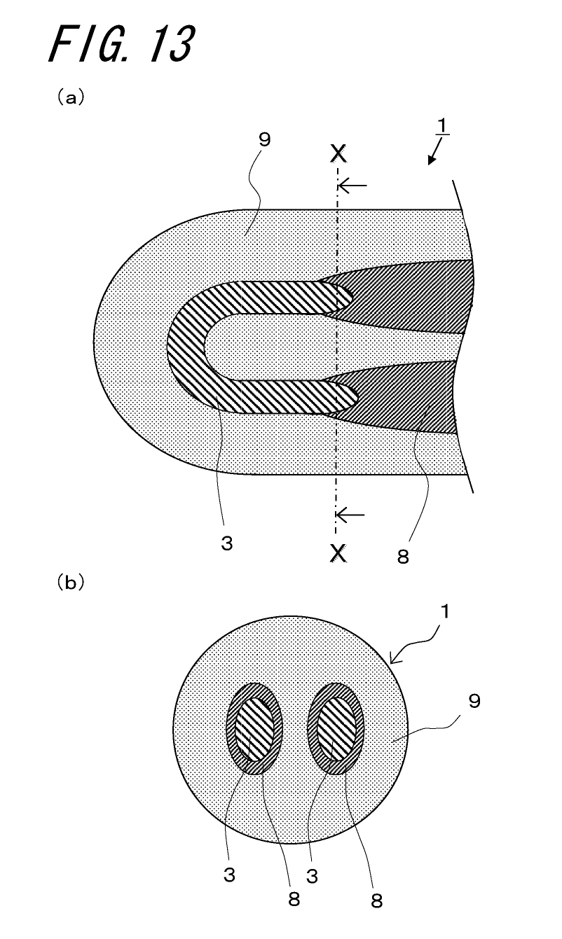

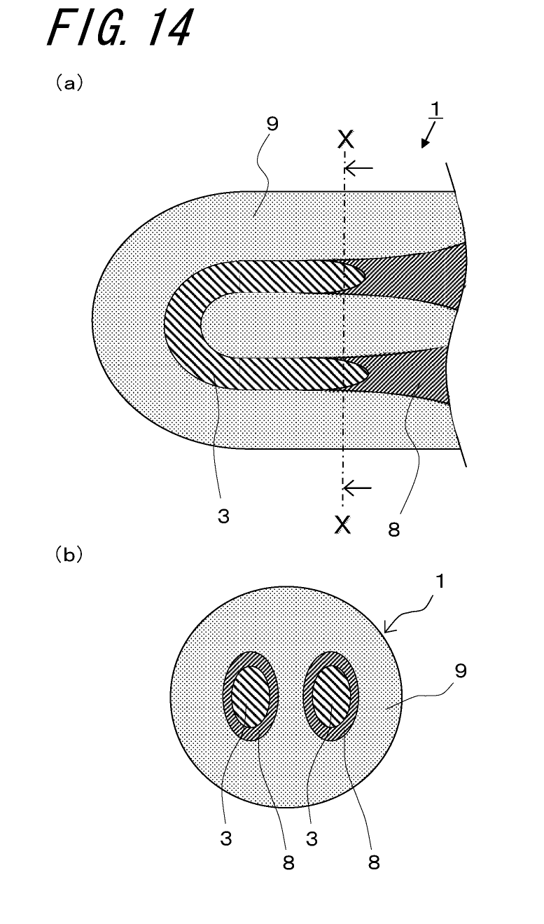

Further, in the heater 1 of this embodiment, it is preferable that, as shown in FIGS. 12 to 14, an end portion of the resistor 3 is formed into a rounded shape as viewed in cross section including an axis of the lead 8. By forming the end portion of the resistor 3 into a rounded shape, stress generated due to local heating caused by lattice vibrations attributed to electronic conduction which is generated by DC components transmitted through a center portion of a conductive body when inrush power is increased is not concentrated on the center portion of the seam portion between the lead 8 and the resistor 3 and is alleviated by being dissipated in the outer peripheral direction. Accordingly, no microcracks are generated in the seam portion and hence, the resistance becomes stable for a long period. Further, the invention is also directed to a glow plug which includes the heater having any one of the above-mentioned constitutions, and a metal holder which is electrically connected to a terminal portion of the lead and holds the heater.

Further, it is preferable that the heater 1 of this embodiment is used in the form of a glow plug which includes the heater 1 having any one of the above-mentioned constitutions, and the metal holder which is electrically connected to a terminal portion 81 of the lead 8 and holds the heater 1. To be more specific, it is preferable that the heater 1 is used in the form of a glow plug where the resistor 3 having a folded shape is embedded in the inside of the rod-shaped insulating base body 9, the pair of leads 8 is embedded in the inside of the insulating base body 9 in a state where the leads 8 are respectively electrically connected to both end portions of the resistor 3, and the metal holder (sheath fitting) which is electrically connected to one lead 8 and a wire which is electrically connected to the other lead 8 are provided.

The metal holder (sheath fitting) is a metal-made cylindrical body for holding the heater 1, and is joined to one lead 8 which is extended to a side surface of the ceramic base body 9 using a brazing material or the like. On the other hand, the wire is joined to the other lead 8 which is extended to a rear end of another ceramic base body 9 using a brazing material or the like. Due to such a constitution, even when the glow plug is used in en engine at a high temperature for a long period in a state where ON/OFF operations of the glow plug are repeated, the resistance of the heater 1 is not changed and hence, it is possible to provide the glow plug which exhibits excellent ignitability at any time.

Next, a method of manufacturing the heater 1 according to this embodiment is explained.

The heater 1 according to this embodiment is formed by injection molding or the like which uses molds having shapes of the resistor 3, the lead 8 and the insulating base body 9 respectively.

Firstly, a conductive paste which contains conductive ceramic powder, a resin binder and the like and is used for forming the resistor 3 and the leads 8 is prepared, and also a ceramic paste which contains insulating ceramic powder, a resin binder and the like and is used for forming the insulating base body 9 is prepared.

Next, a formed body formed of a conductive paste having a predetermined pattern for forming the resistor 3 (formed body a) is formed by injection molding or the like using the conductive paste. Further, in a state where the formed body a is held in the inside of a mold, the conductive paste is filled into the inside of the mold, thus forming a formed body formed of a conductive paste having a predetermined pattern for forming the leads 8 (formed body b). Accordingly, the formed body a and the formed body b which is connected to the formed body a are brought into a state where the formed bodies a and b are held in the mold.

Next, in a state where the formed body a and the formed body b are held in the mold, a portion of the mold is exchanged with a mold for forming the insulating base body 9, and a ceramic paste for forming the insulating base body 9 is filled into the mold. Due to such steps, a formed body (formed body d) of the heater 1 where the formed body a and the formed body b are covered with a formed body (formed body c) formed of the ceramic paste is obtained.

Next, by firing the obtained formed body d at a temperature of 1650° C. to 1780° C. under pressure of 30 MPa to 50 MPa, the heater 1 can be manufactured. Here, it is preferable to perform firing in an atmosphere of a non-oxidizing gas such as a hydrogen gas.

### EXAMPLES

The heater according to examples of the invention was prepared as follows.

Firstly, a formed body a for forming the resistor was prepared by molding a conductive paste containing 50 mass % of tungsten carbide (WC) powder, 35 mass % of silicon nitride (Si₃N₄) powder and 15 mass % of resin binder in a mold by injection molding.

Next, in a state where the formed body a was held in the inside of the mold, the above-mentioned conductive paste for forming the leads was filled into the mold, thus forming a formed body b for forming the leads in a state where the formed body b was connected to the formed body a. Here, as described in Tables 1 and 2, 6 kinds of shapes of joining portions between a resistor and leads were formed using molds having various shapes. The inclination angle of the lead and the inclination angle of the resistor in the joining portion shown in Tables 1 and 2 indicate the degrees of angles at which a side surface of the lead and a side surface of the resistor are inclined with respect to a longitudinal axis of the heater as viewed in cross section by setting the angles in a state where shapes of the lead and the resistor are arranged parallel to the longitudinal direction of the heater as 0°.

Next, in a state where the formed body a and the formed body b were held in the mold, a ceramic paste containing 85 mass % of silicon nitride (Si₃N₄) powder, 10 mass % of oxide of ytterbium (Yb) (Yb₂O₃) which constitutes a sintering aid, and 5 mass % of tungsten carbide (WC) for making a thermal expansion coefficient of the insulating base body approximate a thermal expansion coefficient of the resistor and a thermal expansion coefficient of the lead was molded in a mold by injection molding. Due to such a step, a formed body d where the formed body a and the formed body b were embedded in the formed body c which constitutes the insulating base body was formed.

Next, the obtained formed body d was put into a cylindrical mold made of carbon and, thereafter, the formed body d was sintered by hot-pressing in a non-oxidizing gas atmosphere made of a nitrogen gas at a temperature of 1700° C. and under pressure of 35 MPa, thus manufacturing the heater. A cylindrical metal holder (sheath fitting) was joined to an end portion (terminal portion) of the lead exposed to a surface of the obtained sintered body by blazing, thus manufacturing a glow plug.

A pulse pattern generator was connected to an electrode of the glow plug and a voltage of 7V was applied to the glow plug, and the glow plug was continuously energized with rectangular pulses having a pulse width of 10 μs at pulse intervals of 1 μs. After a lapse of 1000 hours, a rate of change in resistance value between before and after energization ((resistance value after energization−resistance value before energization)/resistance value before energization) was measured. The result of the measurement is shown in Table 1.

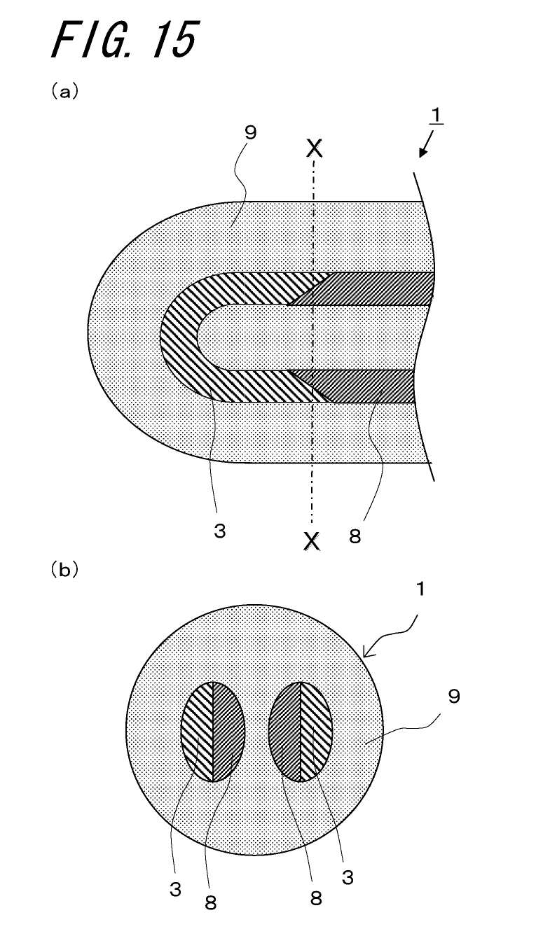

TABLE 1

| | | Cross-sectional | Inclination | Inclination | Portion | | |
|---|---|---|---|---|---|---|---|
| | | area of heat- | angle of | angle of | where | Change | Cracks |
| | Shape of | generating | lead in | resistor in | heat is | rate of | between |
| Sample | joining | portion of | joining | joining | generated | resistance | resistor |
| No. | portion | resistor (mm²) | portion | portion | most | (%) | and lead |
| *1 | FIG. 15 | 0.60 | — | — | Joining | 55 | Present |
| | | | | | portion of | | |
| | | | | | lead and | | |
| | | | | | resistor | | |
| 2 | FIG. 2 | 0.60 | 15° | 0° | Heat- | 5 | Not present |
| | | | | | generating | | |
| | | | | | portion of | | |
| | | | | | resistor | | |
| 3 | FIG. 4 | 0.60 | 15°, 30° | 0° | Heat- | 5 | Not present |
| | | | | | generating | | |
| | | | | | portion of | | |
| | | | | | resistor | | |
| 4 | FIG. 6 | 0.60 | 0° to 30° | 0° | Heat- | 1 | Not present |
| | | | | | generating | | |
| | | | | | portion of | | |
| | | | | | resistor | | |
| 5 | FIG. 10 | 0.60 | 15° | 15° | Heat- | 3 | Not present |
| | | | | | generating | | |
| | | | | | portion of | | |
| | | | | | resistor | | |
| 6 | FIG. 11 | 0.60 | 15° | 15° | Heat- | 0 | Not present |
| | | | | | generating | | |
| | | | | | portion of | | |
| | | | | | resistor | | |

Asterisk “*” indicates sample out of scope of the invention

As shown in Table 1, in Sample No. 1, heat was generated most in the joining portion of the lead and the resistor. When a waveform of a pulse which flows through the heater of Sample No. 1 was checked using an oscilloscope for checking an energized state, a rise of pulse was not steep unlike an input waveform, and it took 1 μs until a voltage reached 7V and the pulse became wavy with overshoot.

It is thought that, in the heater of Sample No. 1, high frequency components included in a rise portion of a pulse are reflected due to mismatching of impedances at a seam portion between the lead and the resistor. Further, also with respect to the result of the measurement that heat was generated most at the joining portion of the lead and the resistor, it is thought that local heating was generated in the seam portion between the lead and the resistor attributed to the reflection of high frequency components.

Further, a change in resistance of the heater of Sample No. 1 between before and after the energization was 55%, that is, extremely large. When the joining portion of the lead and the resistor of Sample No. 1 was observed using a scanning electron microscope after the pulse energization, it was confirmed that microcracks were generated in a joining interface in a direction from an outer periphery of the interface toward the inside of the interface.

On the other hand, with respect to Sample Nos. 2 to 6, a portion where heat was generated most was a heat-generating portion of the resistor on a distal end of the heater. Further, when a waveform of a pulse which flows through the heater was checked using an oscilloscope so as to check an energization state, the pulse had substantially the same shape as the input waveform.

This result shows that matching of impedances was secured at the seam portion between the lead and the resistor and hence, the heater was energized without causing the reflection of high frequency components included in a rise portion of a pulse at the seam portion between the lead and the resistor.

Further, a change in resistances of the heaters of Sample Nos. 2 to 6 between before and after the energization was 5%, that is, small. When the joining portion of the lead and the resistor of each sample was observed using a scanning electron microscope after the pulse energization, no microcracks were observed.

Next, a DC power source was connected to the heater and an applied voltage was set such that a temperature of the resistor becomes 1400° C., and a cycle which is constituted of (1) energization for 5 minutes and (2) non-energization for 2 minutes was repeated 10,000 times. A change rate of a resistance value of the heater between before and after the energization was measured.

TABLE 2

| | | Cross-sectional | Inclination | Inclination | | |
|---|---|---|---|---|---|---|
| | | area of heat- | angle of | angle of | Change | Cracks |
| | Shape of | generating | lead in | resistor in | rate of | between |
| Sample | joining | portion of | joining | joining | resistance | resistor |
| No. | portion | resistor (mm²) | portion | portion | (%) | and lead |
| *1 | FIG. 15 | 0.60 | — | — | 55 | Present |
| 2 | FIG. 2 | 0.60 | 15° | 0° | 5 | Not present |
| 3 | FIG. 4 | 0.60 | 15°, 30° | 0° | 5 | Not present |
| 4 | FIG. 6 | 0.60 | 0° to 30° | 0° | 1 | Not present |
| 5 | FIG. 10 | 0.60 | 15° | 15° | 3 | Not present |
| 6 | FIG. 11 | 0.60 | 15° | 15° | 0 | Not present |

Asterisk “*” indicates sample out of scope of the invention

As shown in Table 2, a change in resistance of the heater of Sample No. 1 between before and after the energization was 55%, that is, extremely large. When the joining portion of the lead and the resistance of Sample No. 1 was observed using a scanning electron microscope after the DC energization, it was confirmed that microcracks were generated in a joining interface in a direction from an outer periphery of the interface toward the inside of the interface.

On the other hand, a change in resistances of the heaters of Sample Nos. 2 to 6 between before and after the energization was 5%, that is, small. When the joining portion of the lead and the resistor of each sample was observed using a scanning electron microscope after the pulse energization, no microcracks were observed.

As has been described heretofore, the lead is made to have a portion whose profile is gradually narrowed toward the distal end on a heat-generating portion side of the lead, the joining portion of the resistor and the lead is a region where the resistor is spaced apart from the insulating base body through the lead as viewed in cross section perpendicular to the axial direction of the lead. Accordingly, irrespective of whether driving is pulse driving or DC driving, even when a rise of power inrush becomes steep, no microcracks or the like are generated in the seam portion between the lead and the heat-generating portion and hence, the resistance becomes stable for a long period. Accordingly, the reliability and the durability of the heater are enhanced.

### REFERENCE SIGNS LIST

1: Heater
3: Resistor
4: Heat-generating portion
8: Lead
81: Terminal portion
9: Insulating base body

1. A heater, comprising:
a resistor comprising a heat-generating portion;
a lead joined to an end portion of the resistor to surround the end portion of the resistor; and
an insulating base body covering the resistor and the lead,
the lead being made to have a portion whose profile is narrowed toward a distal end on a heat-generating portion side of the lead,
a joining portion of the resistor and the lead comprising a region where the resistor is spaced apart from the insulating base body through the lead as viewed in cross section perpendicular to an axial direction of the lead.

2. The heater according to claim 1, wherein the portion of the lead having the profile which is narrowed comprises a plurality of inclined regions as viewed in cross section including an axis of the lead, and inclination on a distal end side is gentler than inclination on a rear end side in the plurality of inclined regions.

3. The heater according to claim 1, wherein the resistor includes a tapered region in the joining portion.

4. The heater according to claim 3, wherein the distal end of the lead on the heat-generating portion side is positioned closer to the heat-generating portion than an initiation point of the tapered region.

5. The heater according to claim 3, wherein the distal end of the lead on the heat-generating portion side is positioned at an initiation point of the tapered region.

6. The heater according to claim 1, wherein an end portion of the resistor is formed in a round shape as viewed in cross section including an axis of the lead.

7. A glow plug, comprising:
the heater according to claim 1; and
a metal holder which is electrically connected to a terminal portion of the lead and holds the heater.
